(19) United States
(12) Patent Application Publication
(10) Pub. No.: US 2008/0257845 A1
(43) Pub. Date: Oct. 23, 2008

(54) Self Righting Baby Bottle

(76) Inventor: Esmeralda Reyes Rossi, Chandler, AZ (US)

Correspondence Address: SCHMEISER OLSEN & WATTS, 18 E UNIVERSITY DRIVE, SUITE # 101, MESA, AZ, 85201, US

(21) Appl. No.: 12/108,453

(22) Filed: Apr. 23, 2008

Related U.S. Application Data
(60) Provisional application No. 60/925,780, filed on Apr. 23, 2007.

(51) Int. Cl. A61J 9/00; B65D 90/02; B65D 23/10

(52) U.S. Cl. 215/11.1; 215/373; 215/396

(57) ABSTRACT

A baby bottle container includes a cap portion which allows fluid to flow therethrough and a bottle engaged with the cap, wherein the bottle includes a bottle body and a weighted end piece which biases the bottle body to an upright position in response to engaging a support structure. The weighted end piece includes a smooth curved hemispherical surface. The weighted end piece biases the bottle body to an upright position relative to the support structure.

### CROSS REFERENCE TO RELATED APPLICATIONS

This patent application claims priority to U.S. Provisional Application No. 60/925,780, which was filed on Apr. 23, 2007 by the same inventor, the contents of which are incorporated herein by reference in their entirety.

### BACKGROUND OF THE INVENTION

1. Field of the Invention

This invention relates generally to bottles for nursing.

2. Description of the Related Art

There are many different types of baby bottles, such as those disclosed in U.S. Pat. Nos. 5,749,483, 5,662,406, 6,783,020, D559,622 and D362,306, as well as U.S. Patent Application No. 20050205589, the contents of all of which are incorporated herein by reference. The baby bottle typically includes a bottle portion with a threaded opening for receiving a cap. The cap can be of many different types such as a nipple cap and sippy cup cap. More information regarding a sippy cup cap is provided in U.S. Pat. No. D559,622 and U.S. Patent Application No. 20050205589.

Some of these baby bottles include caps that make them spill proof so that liquid contained by the bottle portion is less likely to flow out of the bottle in response to the bottle being knocked over. However, the cap can undesirably engaged the floor or the ground if it is knocked over. It is undesirable to have an infant put a dirty cap in his or her mouth. Accordingly, what is needed is a baby bottle with a cap that is less likely to engage the ground when the baby bottle is knocked over.

### BRIEF SUMMARY OF THE INVENTION

The present invention provides a container, which includes a cap which allows fluid to flow therethrough and a bottle engaged with the cap, wherein the bottle includes a bottle body and a weighted end piece which biases the bottle body to an upright position. The bottle body moves to the upright position in response to fluid being removed therefrom. The weighted end piece moves the center of mass of the bottle away from the cap.

In some embodiments, the weighted end piece is repeatably moveable between positions engaged with and disengaged from the bottle body. The weighted end piece can include a curved lower surface, and the weighted end piece can be thicker than the bottle body.

The present invention provides a container, which includes a cap which allows fluid to flow therethrough and a bottle engaged with the cap, wherein the bottle includes a bottle body and a weighted end piece which is curved and includes thicker material than the bottle body. The weighted end piece biases the bottle body to an upright position. The bottle moves to the upright position in response to being tilted. The weighted end piece biases the bottle body from a tilted position to an upright position. The bottle moves to the upright position in response to fluid being removed from it. The weighted end piece can be repeatably moveable between positions engaged with and disengaged from the bottle body. The weighted end piece typically includes a smooth curved hemispherical surface.

The present invention provides apparatus, which includes a support structure, a cap portion which allows fluid to flow therethrough, and a bottle engaged with the cap, wherein the bottle includes a bottle body and a weighted end piece which biases the bottle body to an upright position in response to engaging the support structure. The weighted end piece can include a smooth curved hemispherical surface. The weighted end piece biases the bottle body to an upright position relative to the support structure. The amount of bias provided by the weighted end piece depends on the amount of fluid contained by the bottle. The bottle moves the cap away from the support structure in response to being tilted. The weighted end piece biases the bottle body from a tilted position to an upright position relative to the support structure. The bottle body moves to the cap away from the support structure in response to fluid being removed therefrom.

These and other features, aspects, and advantages of the present invention will become better understood with reference to the following drawings and description.

### BRIEF DESCRIPTION OF THE DRAWINGS

FIG. 1a is a perspective view of a baby bottle container, in accordance with the invention.

FIG. 1b is a side view of the baby bottle container of FIG. 1a.

FIG. 1c is a top view of the baby bottle container of FIG. 1a.

FIG. 1d is a perspective view of a sippy cup cap which can be used with a baby bottle container, in accordance with the invention.

FIG. 2 is a perspective view of a baby bottle container, in accordance with the invention, having a removeable weighted end piece.

FIG. 3a is a side view of another embodiment of a baby bottle container, in accordance with the invention.

FIGS. 3b and 3c are side views of the baby bottle container of FIG. 3a in upright and tilted positions, respectively.

FIGS. 4a, 4b and 4c are top views of a bottle handle, in accordance with the invention.

FIG. 4d is a cut-away view of the bottle handle of FIG. 4a.

### DETAILED DESCRIPTION OF THE INVENTION

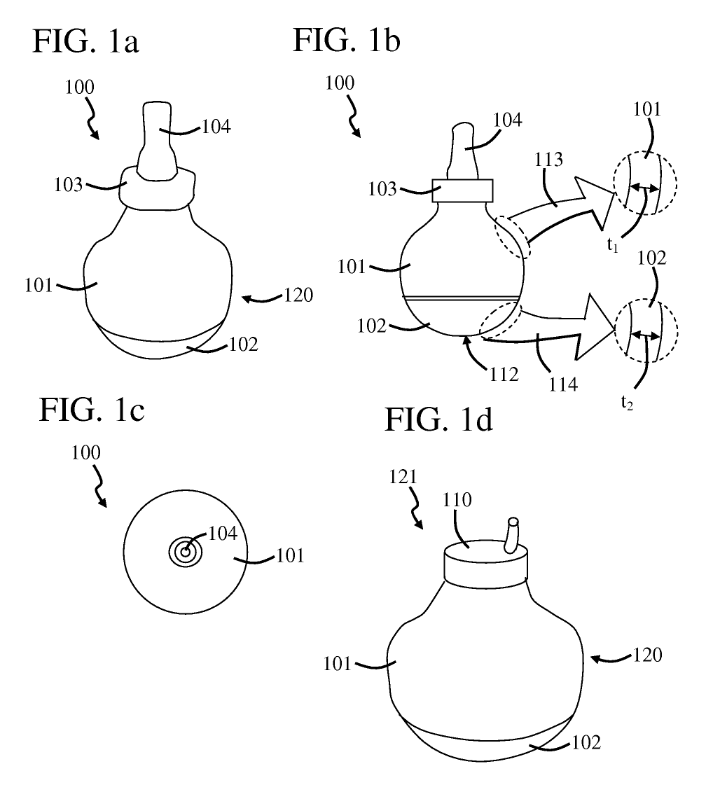

FIG. 1a is a perspective view of a baby bottle container 100, in accordance with the invention. Further, FIG. 1b is a side view of baby bottle container 100 and FIG. 1c is a top view of baby bottle container 100. In this embodiment, baby bottle container 100 includes a cap 103 and a nipple 104 which allows fluid to flow therethrough. It should be noted that nipple 104 can be replaced with other devices that allow fluid to flow therethrough.

For example, FIG. 1d is a perspective view of a sippy cup cap 110 which can be used with a baby bottle 121, in accordance with the invention. Sippy cup caps are typically designed so that they are spill proof. Baby bottle 121 is the same or similar to bottle 100, but it typically has larger dimensions because sippy cup cap 110 typically has larger dimensions than cap 103. For example, sippy cup cap 110 typically has a larger diameter than cap 103. More information regarding sippy cup cap 110 can be found in U.S. Pat. No. D559,622 and U.S. Patent Application No. 20050205589.

Baby bottle container 100 includes a bottle 120 engaged with cap 103, wherein bottle 120 includes a bottle body 101 and a weighted end piece 102 which biases the bottle body 101 to an upright position. Weighted end piece 102 biases bottle body 101 to an upright position. Bottle 120 moves to the upright position in response to being tilted. Further, weighted end piece 102 biases bottle body 101 from a tilted position to an upright position.

Weighted end piece 102 includes a curved lower surface 112. In this particular embodiment, curved lower surface 112 is a smooth curved hemispherical surface. In some embodiments, surface 112 consists of a smooth curved hemispherical surface. In other embodiments, surface 112 consists essentially of a smooth curved hemispherical surface. In some embodiments, surface 112 has a single curvature. In some embodiments, surface 112 has one curvature.

Weighted end piece 102 can be weighted in many different ways. For example, in this embodiment, weighted end piece 102 is thicker than bottle body 100, as indicated by indication arrows 113 and 114. Indication arrow 113 indicates that bottle body 101 has a thickness t₁ and indication arrow 114 indicates that weighted end piece 102 has a thickness t₂, wherein thickness t₂ is greater than thickness t₁. In this way, weighted end piece 102 is heavier than bottle body 100. Weighted end piece 102 can be made so it is heavier than bottle body 101 in many other ways, such as by forming it of denser material.

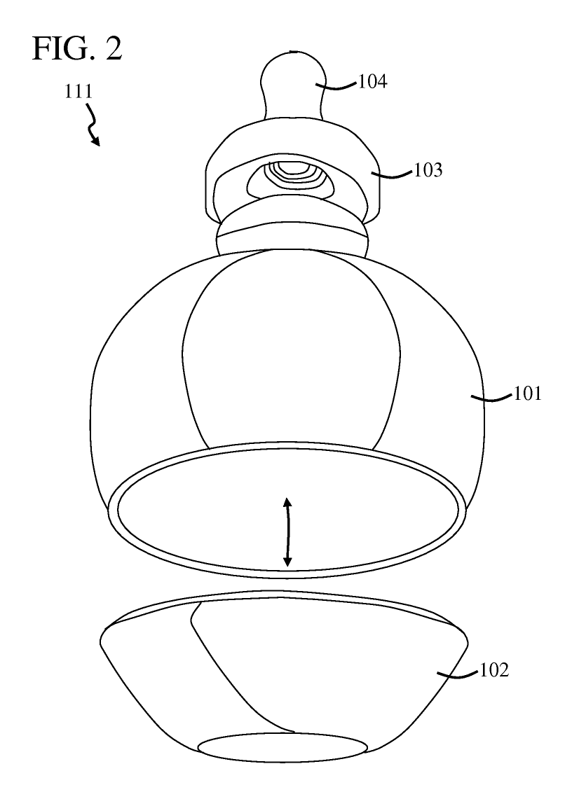

FIG. 2 is a perspective view of a baby bottle container 111, in accordance with the invention, having a removeable weighted end piece 102. In this embodiment, weighted end piece 102 is repeatably moveable between positions engaged with and disengaged from bottle body 101. Weighted end piece 102 can be repeatably moveable between positions engaged with and disengaged from bottle body 101 in many different ways. In this embodiment, weighted end piece 102 and bottle body 101 are threadingly engaged together. In other embodiments, they can be clipped together or another type of fastener can be used. It is useful to be able to disengage weighted end piece 102 from bottle body 101 for many different reasons, such as to clean them.

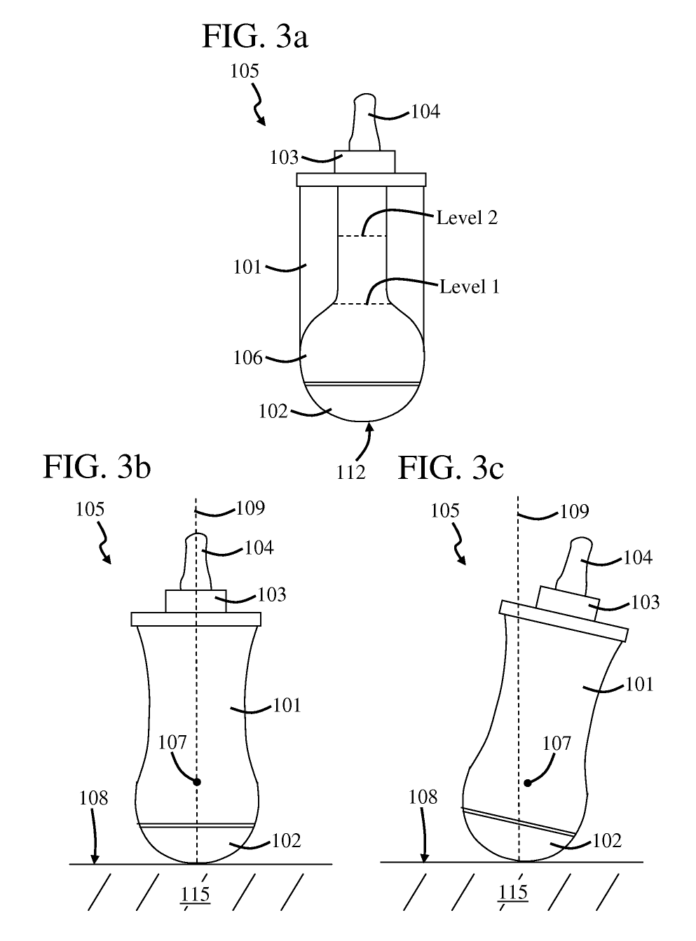

FIG. 3a is a side view of another embodiment of a baby bottle container 105, in accordance with the invention. Further, FIGS. 3b and 3c are side views of baby bottle container 105 in upright and tilted positions, respectively. In this embodiment, baby bottle container 105 is carried by a support structure 115, which can be of many different types, such as a table and floor. Baby bottle container 105 includes bottle body 101 engaged with cap 103. Cap 103 includes nipple 104 which allows fluid to flow therethrough. Bottle container 105 includes a weighted end piece 102 which moves center of mass 107 of bottle container 105 away from cap 103. Weighted end piece 102 moves center of mass 107 of bottle container 105 towards support structure 115. Weighted end piece 102 includes smooth curved hemispherical surface 112 which engages surface 108 of support structure 115.

Weighted end piece 102 biases bottle body 101 to an upright position in response to engaging support structure 115. Weighted end piece 102 biases bottle body 101 to an upright position relative to support structure 115. Bottle body 101 moves cap 103 away from support structure 115 in response to being tilted. Weighted end piece 102 biases the bottle body 101 from a tilted position to an upright position relative to the support structure 115.

In accordance with the invention, bottle body 101 moves to the upright position in response to fluid being removed therefrom. In this way, bottle container 105 moves to the upright position in response to fluid being removed from it. Bottle body 101 moves cap 103 away from support structure 115 in response to fluid being removed therefrom.

The amount of bias provided by weighted end piece 102 to bottle body 101 depends on the amount of fluid contained by bottle container 105. For example, weighted end piece 102 provides a larger bias to bottle body 101 when the fluid contained therein is at a Level 1 of FIG. 2a. Further, weighted end piece 102 provides a smaller bias to bottle body 101 when the fluid contained therein is at a Level 2 of FIG. 2a.

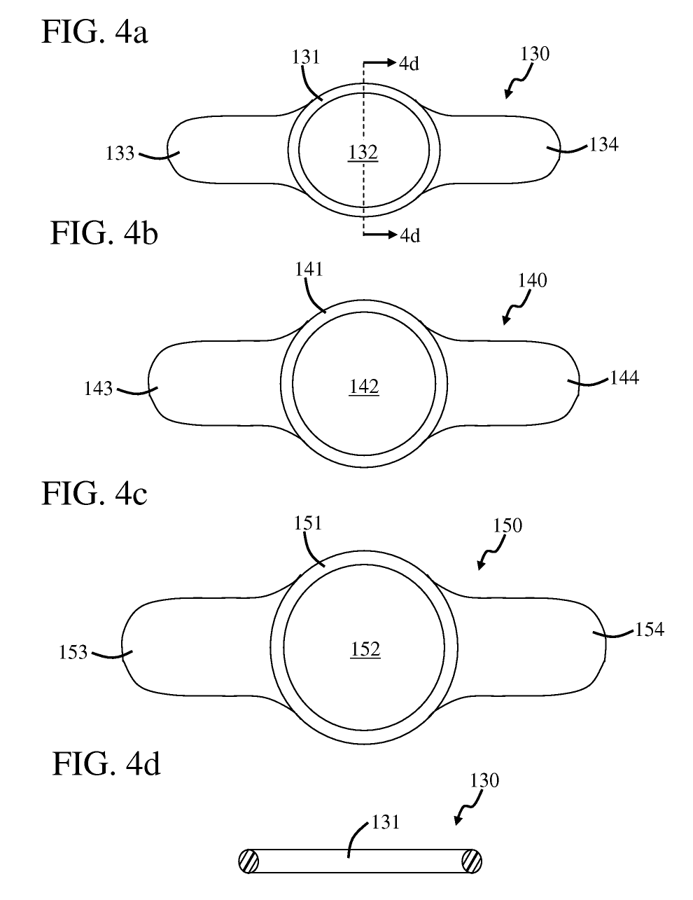

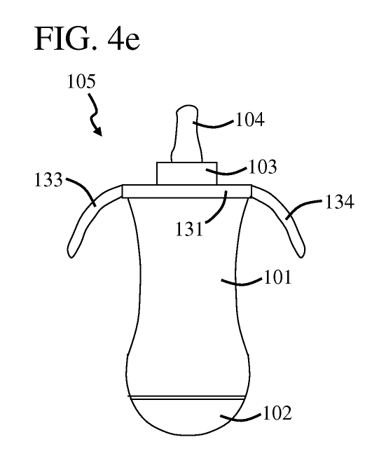

FIGS. 4a, 4b and 4c are top views of a bottle handle, in accordance with the invention. Examples of bottle handles are disclosed in U.S. Pat. Nos. 5,170,533 and 5,480,043, the contents of both of which are incorporated herein by reference.

In FIG. 4a, a bottle handle 130 is shown, wherein bottle handle 130 includes a ring body 131 with a central opening 132. Ring body 131 is toroidal in shape, as shown in FIG. 4d, which is a cut-away view of bottle handle 130. Bottle handle 130 includes opposed handles 133 and 134 extending outwardly from ring body 131. Bottle handle 130 can be made of many different types of material, but it is typically made of a flexible and resilient material, such as rubber and plastic. Opening 132 is sized and shaped to receive an end opening of a bottle body, such as bottle body 101. Ring body 131 can be expanded because it is made of a flexible and resilient material, so that opening 132 is expanded and bottle body can be extended therethrough. Ring body 131 can also be expanded, so that opening 132 is expanded and bottle body can be removed therefrom. In this way, bottle handle 130 is repeatably moveable between positions engaged with and disengaged from bottle body 101.

A cap, such as cap 103 and sippy cup cap 110, can be positioned so that bottle handle 130 is between them. One such example is shown in FIG. 4e, wherein bottle handle 130 is carried by baby bottle container 105. In this way, handles 133 and 134 can be used to handle bottle body 101.

In FIG. 4b, a bottle handle 140 is shown, wherein bottle handle 140 includes a ring body 141 with a central opening 142. Ring body 141 is toroidal in shape, as discussed above with ring body 131. Bottle handle 140 includes opposed handles 143 and 144 extending outwardly from ring body 141. Opening 142 is sized and shaped to receive an end opening of a larger bottle body than opening 132.

In FIG. 4c, a bottle handle 150 is shown, wherein bottle handle 150 includes a ring body 151 with a central opening 152. Ring body 151 is toroidal in shape, as discussed above with ring body 131. Bottle handle 150 includes opposed handles 153 and 154 extending outwardly from ring body 151. Opening 152 is sized and shaped to receive an end opening of a larger bottle body than openings 132 and 142. In this way, a number of different sized bottle handles are provided to accommodate a number of different sizes of bottle bodies.

The embodiments of the invention described herein are exemplary and numerous modifications, variations and rearrangements can be readily envisioned to achieve substantially equivalent results, all of which are intended to be embraced within the spirit and scope of the invention.

1. A container, comprising:
a cap which allows fluid to flow therethrough; and
a bottle engaged with the cap, the bottle including a bottle body and a weighted end piece which biases the bottle body to an upright position.

2. The container of claim 1, wherein the weighted end piece is repeatably moveable between positions engaged with and disengaged from the bottle body.

3. The container of claim 1, wherein the weighted end piece includes a curved lower surface.

4. The container of claim 1, wherein the bottle body moves to the upright position in response to fluid being removed therefrom.

5. The container of claim 1, wherein the weighted end piece is thicker than the bottle body.

6. The bottle of claim 1, wherein the weighted end piece moves the center of mass of the bottle away from the cap.

7. A container, comprising:
a cap which allows fluid to flow therethrough; and
a bottle engaged with the cap, the bottle including a bottle body and a weighted end piece which is curved and includes thicker material than the bottle body.

8. The container of claim 7, wherein the weighted end piece biases the bottle body to an upright position.

9. The container of claim 7, wherein the bottle moves to the upright position in response to being tilted.

10. The container of claim 7, wherein the weighted end piece biases the bottle body from a tilted position to an upright position.

11. The container of claim 7, wherein the bottle moves to the upright position in response to fluid being removed from it.

12. The container of claim 7, wherein the weighted end piece is repeatably moveable between positions engaged with and disengaged from the bottle body.

13. The container of claim 7, wherein the weighted end piece includes a smooth curved hemispherical surface.

14. Apparatus, comprising:
a support structure;
a cap portion which allows fluid to flow therethrough;
a bottle engaged with the cap, the bottle including a bottle body and a weighted end piece which biases the bottle body to an upright position in response to engaging the support structure.

15. The apparatus of claim 14, further including a bottle handle with a ring body and opposed handles.

16. The container of claim 15, wherein the bottle handle is repeatably moveable between positions engaged with and disengaged from the bottle body.

17. The apparatus of claim 14, wherein the weighted end piece biases the bottle body to an upright position relative to the support structure.

18. The apparatus of claim 16, wherein the amount of bias provided by the weighted end piece depends on the amount of fluid contained by the bottle.

19. The apparatus of claim 14, wherein the weighted end piece biases the bottle body from a tilted position to an upright position relative to the support structure.

20. The apparatus of claim 14, wherein the bottle body moves the cap away from the support structure in response to fluid being removed therefrom.
